(19) United States
(12) Patent Application Publication
(10) Pub. No.: US 2005/0202114 A1
(43) Pub. Date: Sep. 15, 2005

(54) Granulating device

(75) Inventor: Gregor Chszaniecki, Hannover (DE)

Correspondence Address: CROWELL & MORING LLP;INTELLECTUAL PROPERTY GROUP, P.O. BOX 14300, WASHINGTON, DC, 20044-4300, US

(73) Assignee: Berstorff GmbH, Hannover (DE)

(21) Appl. No.: 11/041,938

(22) Filed: Jan. 26, 2005

Related U.S. Application Data
(63) Continuation of application No. PCT/EP03/08027, filed on Jul. 23, 2003.

(30) Foreign Application Priority Data
Jul. 27, 2002 (DE) 102 34 229.6

(51) Int. Cl. B29C 59/00

(52) U.S. Cl. 425/308; 425/381

(57) ABSTRACT

A granulating device is provided, especially one used to produce plastic granulates, having a screen device that contains a housing and at least one flow passage and can be connected to an extruder, and a granulator that is arranged downstream from the flow direction of the screen device. To obtain quick disassembly and assembly of the extruder screws, the granulator is removable from the screen device, especially by being pivoted away from it. The screen device is designed such that in the operating and assembly states of the screen device, an opening that is arranged coaxially to the extruder screws can be produced in the screen device through which the extruder screw or screws can be removed completely from the extruder cylinder.

### CROSS-REFERENCE TO RELATED APPLICATIONS

This application is a continuation of PCT Application No. PCT/EP03/08027 filed on Jul. 23, 2003, which claims priority to German Application No. 102 34 229.6 filed Jul. 27, 2002.

### BACKGROUND AND SUMMARY OF THE INVENTION

The present invention relates to a granulating device, and, in particular to a granulating device used to produce plastic granulates.

In a representative granulating device, especially in an underwater granulator, a rotating knife-blade tool of a cutting device cuts met strands, which are squeezed out of an extruder through a perforated screen equipped with nozzle bores, into short sections so that a granulate is formed. In an underwater granulator, the cutting plate is followed by a chamber filled with process water, which serves to further harden and transport the granulates. The granulate/water mixture is transported via an outlet pipe to a separating device. There, the solidified granulates are separated from the process water and subsequently dried.

Typically, the granulator is coupled to the extruder during operation, usually by being flange-mounted. For maintenance work, for example the replacement of a cutting plate, the granulator must be dismounted from the extruder. For reasons of quick attachment and disassembly, it has proven advantageous to attach the underwater granulator to the extruder in an articulated fashion so that it only has to be folded away from the extruder for disassembly and toward the extruder for attachment.

In the case of underwater granulating processes, often a screen device, for example a screen changer—sometimes called a “melt filter”—is arranged, in order to collect contaminants in the plastic melt.

Screen changers available on the market, however, must be completely dismounted, including the granulator arranged thereafter, and be removed if the extruder screw is to be pulled from the extruder. This procedure is both cumbersome and time-consuming.

The underwater granulator described in German patent document DE 101 51 434 already releases the area in front of the extruder when the machine is open and ensures (in conjunction with quick disassembly of a cutting plate), by means of a union nut, that the screw can be pulled out of a extruder cylinder in the shortest possible time. If, however, a screen changer is provided, then the latter is arranged between an extruder and the granulating device, so that removing the screw from the extruder becomes impossible.

It is the object of the present invention to provide a design in which disassembly and assembly of the extruder screw or screws (for example, from a twin-screw extruder) are possible quickly and without complications even with a representative device.

The objective is achieved by providing a granulating device, especially one used to produce plastic granulates, having a screen device including a housing having at least one flow passage that can be connected to an extruder, and a granulator that is arranged downstream in the flow direction of the screen device. The granulator can be removed from the screen device, especially by being pivoted away from it. The screen device is designed such that in the operating and assembly states of the screen device an opening that is arranged coaxially to the extruder screws can be produced in the screen device through which the extruder screw or screws can be removed completely from the extruder cylinder.

As a result of the present invention, even in a granulating device of the above-mentioned type, more than just the granulator can be removed from the screen device, especially in a swiveling motion. In accordance with the invention, the screen device, in combination with the removable granulator, is designed such that in the operating and assembled state of the screen device, an opening can be produced in the screen device that is arranged coaxially to the extruder screws (worm gears), thus making the extruder screw or screws completely removable from the extruder cylinder. In other words, the screen device is designed such that overall an opening can be created, with which the extruder screws can be pulled through while the granulating device is pivoted to the side. In particular, the combination of the fold-away granulator and correspondingly designed screen device enables a fast and uncomplicated disassembly and assembly of the extruder screws arranged in the extruder.

In order to be able to pull the extruder screws through the screen device, either an opening must be provided in the screen device which does not have a screen, or in the case of an opening with a screen, this screen can be removed.

In accordance with a preferred embodiment of the granulating device, the screen device includes a screen changer with a housing and at least one screen holder that is arranged adjustably in the housing, which screen holder contains at least one screen that is incorporated in a flow passage. Depending upon the design of the screen changer, several screens with corresponding flow passages can be arranged in the screen device, which optionally and alternately can be brought into an overlapping position with a flow passage of the housing to enable passage of the flow. Of course, it is also possible, in addition to a flow passage, to provide an opening without a screen device, through which then the extruder screws can be pulled. The actual screen consists in general of a simple wire cloth, which is disposed of after use and replaced with a new wire cloth. During operation, the wire cloth is clamped between a screen supporting plate and a retaining frame. Alternatively, a single-bolt screen changer or a screen changer with two or more screen retainers can be provided.

In any case, an opening must be possible in the screen device, which in terms of its dimension is designed such that the extruder screws can be pulled through without coming in contact with the screen device.

If a twin screw extruder is used as the extruder, whose extruder screws run in an opposed or synchronized manner, then the opening through which the extruder screws in the end are pulled can take on the form of a spectacle-type bore (eyeglass shape)—thus in harmony with the cross-section of the inner cavity of the extruder cylinder.

In accordance with a preferred embodiment, a screen retainer is arranged displaceably in the housing and comprises two flow passages. Here, at least one flow passage is dimensioned such that the extruder screw or screws can be pulled through the opening that can be created.

Moreover, the distance of the two flow passages in the screen retainer is preferably smaller than the width of the corresponding opening in the housing itself.

In this way, the melt flow can be maintained when changing the screen, since melt already starts flowing through the second opening when the first opening still has a partial overlap with the opening of the housing. Beyond that, it is advantageous if the housing and flow passages and/or their spacings are dimensioned such that a flow passage of the screen retainer is located entirely outside the housing and, hence, freely accessible, while on the other flow passage of the screen retainer, passage of the plastic melt is still maintained. In this case, a screen in a flow passage of the screen retainer is accessible from the outside and can be dismounted, while the operation of the granulating device overall is maintained. A shut-off of the extruder in preparation for a screw disassembly hence does not occur until immediately before disassembly.

To move the screen retainer of a screen changer back and forth, a drive such as a piston/cylinder arrangement, a hydraulic device or a different type of drive can be provided.

In accordance with a preferred embodiment of the granulating device, the cutting plate of the granulating device is attached on the granulator side to the screen device, for example, by way of a nut or a quick coupling, and can be removed promptly.

If the granulating device is designed as an underwater granulator, as described in German patent document DE 101 51 434, then the articulated arrangement of the granulating device to the screen device is advantageous, while the inlet and outlet pipes include the pivot joints described in DE 101 51 434. Overall, the present invention of an underwater granulator ensures quick disassembly of the extruder screws and/or corresponding assembly, without requiring cumbersome disassembly of a screen device. Pursuant to a preferred embodiment, it is only necessary to fold away the granulator and pull the extruder screws out through a prepared opening in the screen device.

Other objects, advantages and novel features of the present invention will become apparent from the following detailed description of the invention when considered in conjunction with the accompanying drawings.

### BRIEF DESCRIPTION OF THE DRAWINGS

FIG. 1 is a diagrammatic perspective view of one embodiment of an underwater granulator pursuant to the present invention, in which the extruder screws have been partially disassembled;

FIG. 2 is a perspective partial exploded view of the granulating device and screen device as illustrated in FIG. 1;

FIG. 3 is another perspective view of the granulating and screen devices from FIG. 1; and

FIGS. 4a-4e are various diagrammatic front views of the granulating and screen devices from FIG. 1 shown in different adjustment and disassembly states.

### DETAILED DESCRIPTION OF THE DRAWINGS

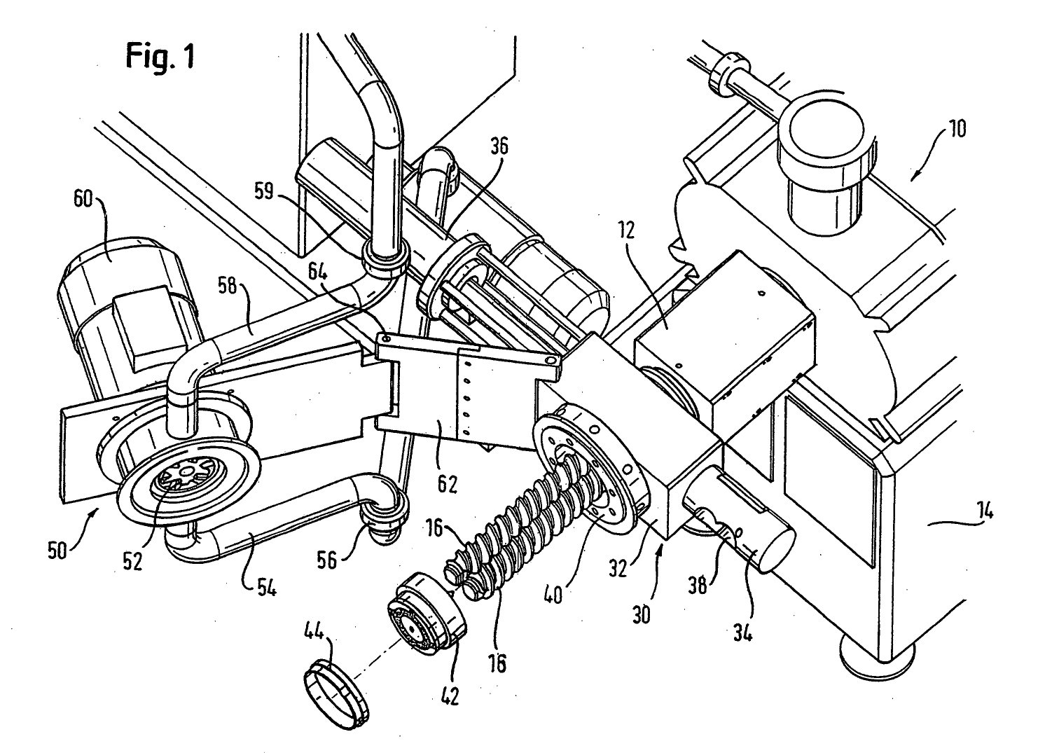

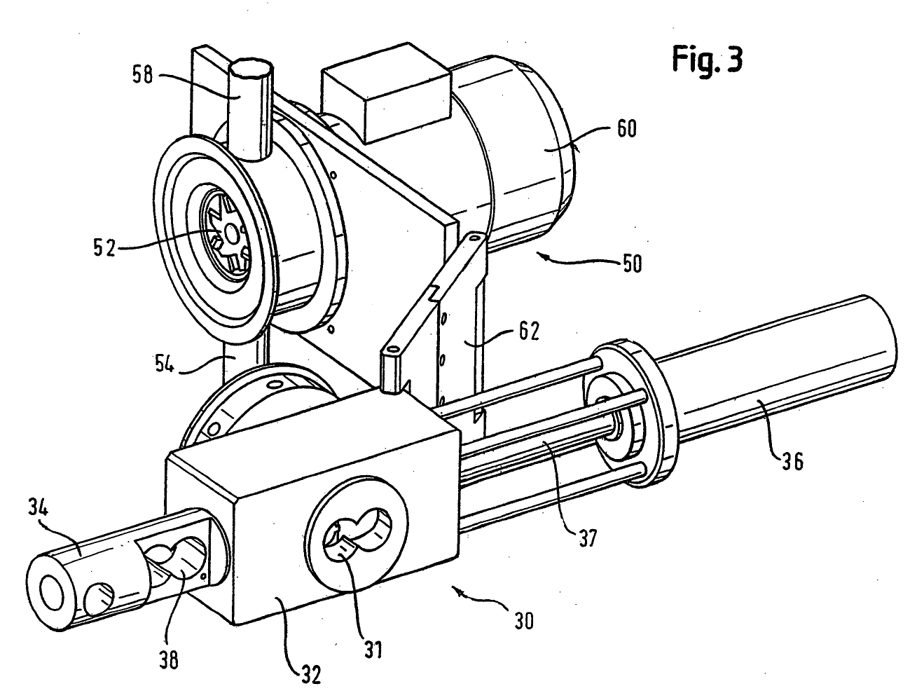

The present invention will be explained on the basis of an underwater granulator comprising a screen device, as represented in FIGS. 1-4e.

FIG. 1 shows the front end of an extruder housing 12 that is arranged on an extruder frame 14, wherein two extruder screws 16 are arranged rotatably in the housing for the production of a plastic melt.

After the extruder 10, a screen changer 30 is provided, which in turn is followed by an underwater granulator 50 (shown in FIG. 1 in a folded-away or open state).

During operation of the present granulating device, the melt produced by the extruder 10 is pushed through a screen of the screen changer 30 in order to eliminate contaminations from the melt. After the screen changer 30, the plastic melt flows in a familiar fashion through a cutting plate 42, where it is cut into small pieces in the form of granulates by a cutting blade 52. The granulates are then removed via the water/granulate outlet 58 by way of water that is supplied from the water inlet 54. The granulates are then fed to a precipitation device (not illustrated in detail here).

During operation of the present granulating device, the cutting plate 42, which is illustrated in FIG. 1 in an exploded view, is attached to the screen device 30 through the use of a union nut 44. Additionally, the granulating device is folded towards the screen device and attached thereto.

In order to ensure better accessibility to the cutting plate 42, as well as to the cutting blade 52, the granulating device 50 is held by a pivoting retaining device 62, which includes a pivot axis 64. The two pipe systems 54 and 58 each include pivot joints 56 and 59, the rotational axes of which coincide coaxially with the pivot axis so that the granulating device can be pivoted away from, or towards, the screen changer without difficulty and without disassembly of the pipes.

Were the screen changer not designed in accordance with the invention, the extruder screws 16 could not be pulled out of the extruder housing 12 in a simple manner. Rather, removal of the screws 16 would have to take place through cumbersome disassembly of the entire screen device or of the screen changer 30, as in the state of the art.

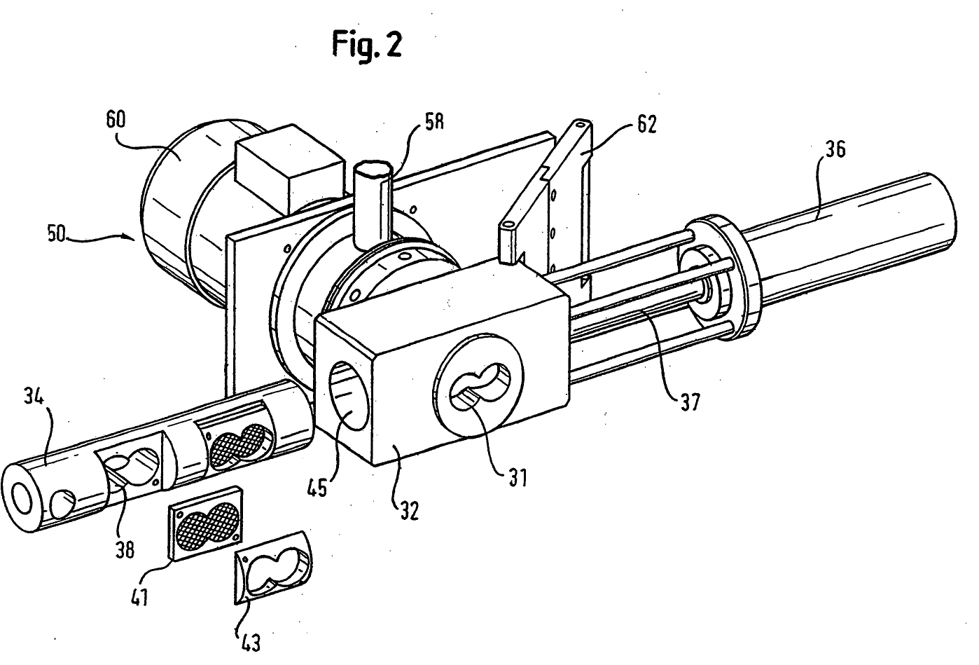

As illustrated in FIG. 2, the screen changer is designed with a housing 32 arranged in a front area, in which housing, by means of a hydraulic piston unit 36 attached to the housing, a screen retainer 34 can be displaced back and forth via a piston rod 37. The screen retainer 34 is designed as a bolt. The screen retainer 34 includes axially spaced and spectacle-like (eyeglass shaped) bore flow passages 38. Via the hydraulic cylinder driver 36, the flow passages can be brought into an overlapping position or partially into an overlapping position optionally or alternately with a likewise spectacle-like bore flow passage 31 incorporated in the housing 32. In front of every flow passage 38, a screen is attached on a screen supporting plate 41 and is fastened to the screen retainer 34 through the use of a retaining frame 43. By loosening the retaining frame 43, the respective screen supporting plate 41 with the corresponding screen can be removed so that the respective flow passage 38 is no longer blocked by the screen, such as a wire cloth screen.

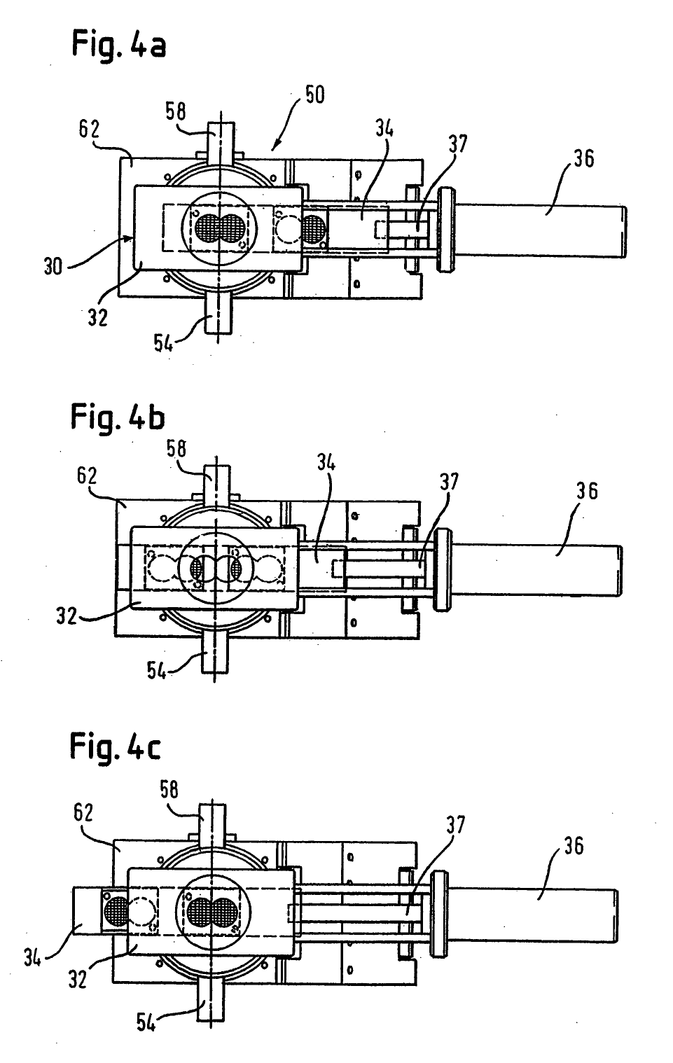

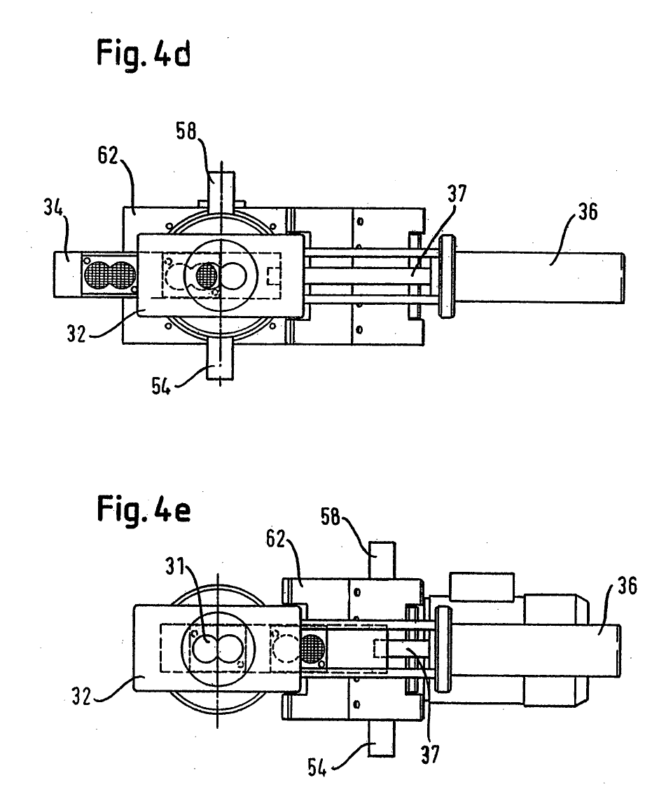

The sequence for disassembly of the extruder screws 16 is shown in FIGS. 4a-4e.

These figures illustrate a screen changer with a granulating device arranged downstream. The extruder, which is arranged on the observer side, is not shown.

In FIG. 4a, the granulating device 50 is still attached to the screen changer 30. On the screen changer, the screen retainer bolt 34 is displaced in the bore 45 of the housing 32, via the hydraulic device 36, so far to the right that the left flow passage 38 completely overlaps with the flow passage 31 of the housing. In this state, the granulating device is operated initially.

In FIG. 4b, the screen retainer bolt 34 is displaced to the left, via the hydraulic drive 36 while connecting the piston rod 37. It can be seen that the right side flow passage 38 (arranged to the right in the screen retainer bolt 34) is already partially overlapping the flow passage 31 of the housing 32, while also at the same time a partial overlap of the first flow passage 38 (arranged on the left) with the flow passage 31 of the housing still exists. This ensures a continuous operation of the granulating device also during the screen changing process.

In FIG. 4c, a position of the screen retainer bolt 34 is then reached in which granulate production is ensured with the second screen.

In FIG. 4d, the screen retainer bolt 34 is displaced so far to the left such that an overlap still exists between the right flow passage in the screen retainer bolt 34 and the flow passage 31 of the housing 32. On the other hand, however, the left flow passage 38 is displaced together with the screen beyond the housing 32. In this state, the retaining frame 43 is accessible from the outside and can be disassembled. After disassembly of the retaining frame 43, the screen supporting plate can be removed together with the screen.

Thereafter, the actual extruder screw disassembly occurs. For this purpose, the extruder is turned off; the screen retainer bolt 34 is displaced so far to the right that the left flow passage 38 completely overlaps the flow passage 31 of the housing 32 so that overall a spectacle-like bore opening through the entire screen changer is provided. If the granulating device 50 is folded away from the screen changer and the cutting plate 42 is removed by loosening the union nut 44, then the extruder screws 16 can be pulled out of the extruder cylinder through the screen changer 30 in the manner illustrated in FIG. 1.

The insertion of the extruder screws occurs in the same fashion in an opposite sequence. Initially, hence, the extruder screws 16 are inserted into the extruder cylinder through the spectacle-like bore opening. Then, the cutting plate 42 is re-attached via the union nut 44, and then the granulating device is swiveled toward the screen changer and is attached thereto. As soon as a screen has been displaced into the flow passage 31 of the housing 32, production can restart.

Overall, the present device offers a very quick and uncomplicated possibility for accessing the extruder screws and pulling them out of the extruder housing without having to disassemble a screen changer or a screen device.

The present invention can, of course, be designed also differently from the attached exemplary embodiment. The decisive factor is only a quick removal of a granulating device from a screen device, and the design of a screen device such that an opening can be created, through which the extruder screws may be guided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### TABLE OF REFERENCE NUMBERS

10 Extruder

12 Extruder Housing

14 Extruder Frame

16 Extruder Screws (Worm Gears)

30 Screen Changer

31 Spectacle-Like Bore

32 Housing of the Screen Changer

34 screen retainer bolt

36 Hydraulic Cylinder

37 Piston Rod

38 Spectacle-Like Bore in the Screen Retainer Bolt

40 retaining device

41 Screen Supporting Plate with Screen

42 Cutting Plate

43 Retaining Plate

44 Union Nut

45 Bore for Screen Bolt

50 Underwater Granulator

52 Cutting Blade

54 Water Inlet Pipe

56 First Pivot Joint

58 Water Outlet Pipe

59 Second Pivot Joint

60 Motor for Underwater Granulator

62 Pivoting Retaining Device

64 Pivot Axis

1. A granulating device, comprising:
a screen device having a housing and at least one flow passage, the screen device being coupleable to an extruder;
a granulator, wherein the granulator is arranged downstream from the screen device in a flow direction and being removable from the screen device; and
wherein the screen device is configured such that in operating and assembly states, an opening arranged coaxially to a screw of the extruder is producible in the screen device, the screw being completely removable from an extruder cylinder through the opening.

2. The granulating device according to claim 1, further comprising:
at least one screen operably configured to be removable from the screen device.

3. The granulating device according to claim 1, wherein the screen device is designed as a screen changer comprising a housing that contains a flow passage, and at least one screen retainer, which screen retainer is arranged adjustably in the housing and contains at least one screen that is arranged in a flow passage.

4. The granulating device according to claim 2, wherein the screen device is designed as a screen changer comprising a housing that contains a flow passage, and at least one screen retainer, which screen retainer is arranged adjustably in the housing and contains at least one screen that is arranged in a flow passage.

5. The granulating device according to claim 3, wherein said at least one screen retainer is displaceably arranged in the housing and comprises at least two flow passages, wherein at least one flow passage is dimensioned such that the extruder screw can be pulled through its opening.

6. The granulating device according to claim 5, wherein the flow passages in the screen retainer can optionally be brought into an at least partially overlapping position with the flow passage of the housing so as to allow passage of an extruded material from the extruder to the granulator.

7. The granulating device according to claim 1, wherein flow passages of the screen device, especially of the housing, and at least one flow passage in the screen retainer are designed as spectacle-like bores when using a twin screw extruder.

8. The granulating device according to claim 3, wherein flow passages of the screen device, especially of the housing, and at least one flow passage in the screen retainer are designed as spectacle-like bores when using a twin screw extruder.

9. The granulating device according to claim 3, wherein a distance between two flow passages in a screen retainer is smaller than a width of the flow passages in the housing.

10. The granulating device according to claim 5, wherein the housing of the screen device and the dimensions of the different flow passages in the screen retainer are selected such that one flow passage of the screen retainer is located completely outside the housing so as to be freely accessible, while another flow passage of the screen retainer maintains a passage for an extruder material through the screen device.

11. The granulating device according to claim 7, wherein the housing of the screen device and the dimensions of the different flow passages in the screen retainer are selected such that one flow passage of the screen retainer is located completely outside the housing so as to be freely accessible, while another flow passage of the screen retainer maintains a passage for an extruder material through the screen device.

12. The granulating device according to claim 9, wherein the housing of the screen device and the dimensions of the different flow passages in the screen retainer are selected such that one flow passage of the screen retainer is located completely outside the housing so as to be freely accessible, while another flow passage of the screen retainer maintains a passage for an extruder material through the screen device.

13. The granulating device according to claim 3, wherein the screen changer comprises a drive for moving the screen retainer.

14. The granulating device according to claim 13, wherein the drive is formed by a piston/cylinder configuration.

15. The granulating device according to claim 1, further comprising:
a cutting plate of the granulator attachable on a granulator side to the screen device.

16. The granulating device according to claim 15, wherein the cutting plate is attachable with a nut or with a quick coupling to the screen device.

17. The granulating device according to claim 1, wherein the granulator is designed as an underwater granulator.

18. The granulating device according to claim 17, wherein the granulator is designed such that it can be attached pivotably to the screen device and that inlet and outlet pipes comprise pivot joints, respectively, the rotational axes of which are designed coaxially to a pivot axis of the granulator.

19. The granulating device according to claim 1, wherein the granulator is operably configured so as to pivoted away from the screen device.

20. A method for removing a screw from an extruder equipped with a granulator having a screen device, the method comprising the acts of:
pivoting a granulator arranged downstream of the screen device in a flow direction away from the screen device;
displacing a screen retainer in a housing of the screen device such that a screen equipped flow passage is readily accessible from outside the housing;
removing the screen within the flow passage;
displacing the screen retainer such that the flow passage is aligned with a flow opening in the housing; and
removing the screw of the extruder through the flow passage of the screen retainer.
